(19) United States
(12) Patent Application Publication
(10) Pub. No.: US 2004/0041111 A1
(43) Pub. Date: Mar. 4, 2004

(54) Valve for regulating liquids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/332,823

(22) PCT Filed: May 10, 2002
(86) PCT No.: PCT/DE02/01695

(30) Foreign Application Priority Data
May 12, 2001 (DE) 10123173.3

(51) Int. Cl. F16K 31/02

(52) U.S. Cl. 251/129.06; 251/335.2

(57) ABSTRACT

The current invention relates to a valve for controlling fluids, which includes a piezoelectric actuator (2), a transmission mechanism for increasing the stroke of the piezoelectric actuator (2), and a control valve (14) that can be actuated by means of the transmission mechanism. In addition a temperature compensation device (27) is provided to compensate for a length change of the piezoelectric actuator (2) induced by a temperature change. The transmission mechanism is embodied in the form of a diaphragm (3) and increases the stroke of the piezoelectric actuator with a transmission ratio a/b. At the same time, the diaphragm (3) produces a seal between the piezoelectric actuator (2) and the fluid to be controlled.

### PRIOR ART

The current invention relates to a valve for controlling fluids, and in particular a fuel injection valve.

Valves for controlling fluids are known in various embodiments. For example, U.S. Pat. No. 4,022,166 has disclosed a piezoelectric fuel injection valve in which a piezoelectric element controls the valve element. The stroke of the piezoelectric element is transmitted to the valve needle directly by means of a lever. In addition, two return springs are provided in order to hold the valve needle and the lever in their respective starting positions. This embodiment with two return springs, which are connected to each other by means of the lever, produces a very oscillation-sensitive mechanism, which is particularly unsuited for a high-pressure injection since the oscillations can build up.

In addition, there are known injectors, which use hydraulic transmission mechanisms to increase the stroke of a piezoelectric actuator. Generally, however, embodiments of this kind are relatively complex in design and are comprised of a large number of parts. It is also necessary to constantly refill the hydraulic transmission mechanism in order to compensate for leakage losses, which makes valves of this kind relatively complex and increases manufacturing costs.

Since the piezoelectric actuators only have a very small stroke capability, which must be increased, the cost of known mechanical or hydraulic transmission mechanisms is relatively high.

### ADVANTAGES OF THE INVENTION

The valve for controlling fluids according to the invention, with the characterizing features of claim 1, has the advantage over the prior art that it only has a small number of parts and is therefore very simply designed and can be inexpensively manufactured. According to the invention, a diaphragm transmission mechanism is used to increase the stroke of a piezoelectric actuator. The use of a diaphragm to mechanically increase the stroke of the piezoelectric actuator permits the elimination of the lever that is otherwise required, which must be manufactured in a high precision manner and usually incurs a very large proportion of the manufacturing costs in mechanical transmission mechanisms. By contrast, a diaphragm can be produced very inexpensively. In addition, the diaphragm performs a sealing function. This achieves a seal preventing leakage in the transmission mechanism according to the invention. Moreover, a temperature compensation device is also provided in order to compensate for a length change of the piezoelectric actuator when there are temperature increases during operation.

Preferably the diaphragm according to the invention is disposed in such a way that it seals the piezoelectric actuator in relation to the control valve. Consequently, the transmission mechanism diaphragm is simultaneously also embodied as a sealing element. By contrast, in the known mechanical and hydraulic transmission mechanisms, an additional seal is required in order to seal the piezoelectric actuator in relation to the fluid to be controlled. Usually a separate seal directly on the piezoelectric actuator is used for this purpose. In the embodiment according to the invention, the diaphragm consequently has a double function of increasing the piezoelectric actuator stroke and sealing the piezoelectric actuator. Thus in particular, the number of parts can be further reduced and the manufacturing costs can be cut.

Preferably, the temperature compensation device is disposed directly on the piezoelectric actuator. This permits a particularly compact design of the valve according to the invention to be achieved.

According to a preferred embodiment of the current invention, the temperature compensation device has a first base part, a second base part, and a sleeve. The first and second base parts are respectively disposed at the end faces of the piezoelectric actuator. The sleeve encompasses the base parts and the piezoelectric actuator. The temperature-induced length change of the first and second base parts and of the piezoelectric actuator essentially corresponds to the temperature-induced length change of the sleeve. In a particularly preferable embodiment, the piezoelectric actuator is encompassed by a thermoconducting medium. In addition, the housing is preferably composed of a material whose expansion coefficient is similar to that of the piezoelectric actuator, for example Invar. The base parts can, for example, be made of aluminum in order to optimize the temperature compensation. The piezoelectric actuator generally has a negative expansion coefficient and the aluminum base parts have a positive expansion coefficient so that in total, the expansion approximately corresponds to the expansion of the housing.

According to a preferred embodiment of the current invention, the force is transmitted from the piezoelectric actuator to the diaphragm by means of a bushing. This produces an annular contact region between the bushing and the diaphragm, thus permitting a uniform introduction of force into the diaphragm.

Preferably a space is provided between the diaphragm and the bushing when the valve is not actuated. This permits temperature-induced length changes of the components still possibly occurring to be compensated for and thus makes it possible to compensate for a residual error that is possibly present in the temperature compensation. It should be noted that it is also possible for the space to be provided between the diaphragm and a valve element of the control valve. However, it is preferable to provide the temperature compensation space between the diaphragm and the bushing since this prevents the error in the temperature compensation from being transmitted along with the transmission of force.

In order to minimize the tensile stresses on the diaphragm, the diaphragm is bent, preferably along its side attachment, at an angle counter to the force direction of the piezoelectric actuator.

According to a preferred embodiment of the current invention, the side attachment region of the diaphragm has a bent region with a particular radius. This produces a continuous transition from the clamping region of the diaphragm to the actual transmission region of the diaphragm, which makes it possible to further reduce the stresses on the diaphragm. Preferably, the diaphragm is clamped at its outer region by means of a ring nut. This permits the diaphragm to be fastened simply, without having to provide the diaphragm with through bores or the like, which reduce its strength. The diaphragm is thereby clamped between the ring nut and a surface oriented toward the ring nut. Preferably the outer edge region of the diaphragm is provided with a seal, for example an O-ring, which is likewise clamped by the ring nut.

In order to permit a resetting of the piezoelectric actuator, preferably a return element is disposed between the piezoelectric actuator and the diaphragm.

Preferably, the control valve is embodied as a valve that opens toward the outside.

In a particularly preferable embodiment, the valve according to the invention is used as a fuel injection valve in a reservoir injection system, for example a common rail system.

### DRAWINGS

An exemplary embodiment of the invention will be explained in detail in the description that follows.

FIG. 1 shows a schematic sectional view of a valve for injecting fuel according to an exemplary embodiment of the current invention and

FIG. 2 shows a schematic, enlarged, partially sectional view of the diaphragm shown in FIG. 1.

### DESCRIPTION OF THE EXEMPLARY EMBODIMENT

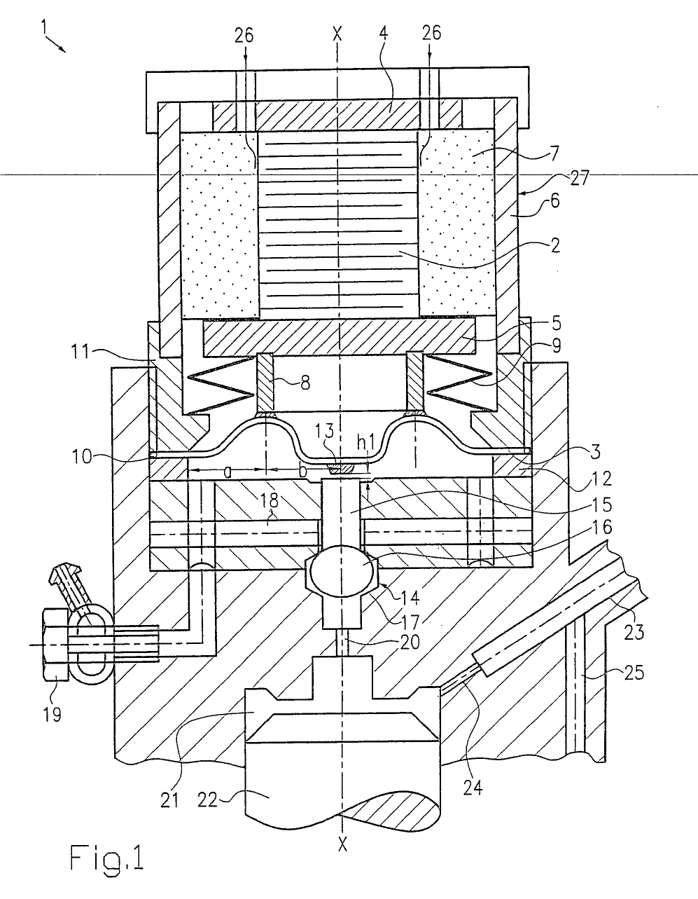

FIG. 1 shows a sectional view of a fuel injection valve for a common rail system according to the current invention.

As shown in FIG. 1, the valve 1 includes a piezoelectric actuator 2 as well as a temperature compensation device 27. The temperature compensation device 27 includes a first base part 4, a second base part 5, a sleeve 6, and a thermoconducting medium 7. The first and second base parts 4, 5 are respectively disposed at the end faces of the piezoelectric actuator 2. The thermoconducting medium 7 encompasses the side regions of the piezoelectric actuator 2. The sleeve 6 serves as a housing and encompasses the two base parts 4, 5 and the thermoconducting medium 7. The base parts 4, 5 are made of aluminum and the sleeve 6 is made of Invar, which has an expansion coefficient similar to that of the piezoelectric actuator. The piezoelectric actuator 2 has a negative expansion coefficient and the aluminum base parts have a high positive expansion coefficient so that their sum approximately equals the expansion of the sleeve 6. In addition, the first base part 4 is provided with through bores in order to permit lines for electrical connections 26 to pass through.

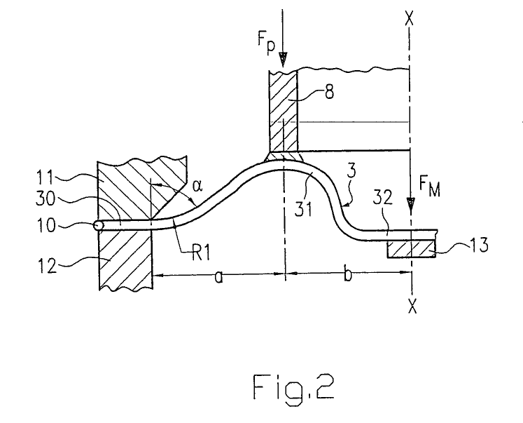

In addition, a diaphragm 3 is provided according to the invention, which has a securing region 30, a force introduction region 31, and a force output region 32 (see FIG. 2). In the securing region 30, which corresponds to the edge region of the diaphragm 3, the diaphragm is firmly clamped between a housing shoulder 12 and a ring nut 11. The force introduction region 31 is bulge-shaped and thus bends counter to the force direction F_{P} of the piezoelectric actuator (see FIG. 2). The force introduction region 31 contacts a bushing 8, which is disposed between the diaphragm and the second base part 5 of the piezoelectric actuator 2. The force output region 32 is embodied as flat and a pressure element 13 is provided on the force output region 32. As shown in FIG. 1, the pressure element 13 is provided on the side of the diaphragm 3 oriented toward the control valve 14.

The control valve 14 includes a valve element 15, a first valve seat 16, and a second valve seat 17. The valve element 15 is comprised of a ball-shaped section and a cylindrical section. In the starting position, the valve element 15 is disposed against the first valve seat 16 and closes it. The control valve 14 is also connected to a leakage connection 19 by means of a line 18. A throttle 20 also connects the control valve 14 to a control chamber 21, which contains a piston 22 that actuates a valve needle, not shown. The control chamber 21 is connected by means of a throttle 24 to an inlet 23 from the common rail. A line 25 branching from the inlet 23 leads to the nozzle.

In addition, a prestressing spring 9 is provided in order to prestress the piezoelectric actuator. The prestressing spring 9 is supported against a shoulder provided on the ring nut 11 and presses against the piezoelectric actuator 2 by means of the second base part 5. The prestressing spring 5 here is embodied as a disk spring.

The operation of the valve 1 according to the invention will be described below.

When the piezoelectric actuator 2 is activated, its stroke is transmitted to the diaphragm 3 by means of the second base part 5 and the bushing 8. More precisely stated, the stroke of the piezoelectric actuator 2 is transmitted to the force introduction region 31 of the diaphragm 3. The diaphragm 3 is firmly clamped between the ring nut 11 and the housing shoulder 12. An O-ring 10 is used to seal this clamped region of the diaphragm 3.

As shown in FIG. 2, the force introduction region 31 of the diaphragm 3 is disposed at an angle α in relation to the securing region 30. A bent region with a radius R1 is provided in a transition region between the securing region 30 and the force introduction region 31. This embodiment at the clamping point of the diaphragm 3 makes it possible to minimize the tensile stresses in the diaphragm. This assures a long service life of the diaphragm 3. The force F_{P} that the piezoelectric actuator 2 exerts on the diaphragm is increased by the diaphragm transmission a/b and at the force output region 32, is transmitted to the control valve 14 as the increased force F_{M} by the pressure element 13. The distance a here is the distance between the center of the introduced force F_{P} of the piezoelectric actuator and the inner edge region of the clamped diaphragm, and the distance b is the distance from the center of the introduced force F_{P} to the center line X-X of the valve (see FIG. 2).

The increased stroke of the piezoelectric actuator is transmitted to the valve element 15 of the control valve 14, causing the valve element 15 to lift up from its first valve seat 16. It lifts up by such a distance that it does not yet rest against the second valve seat 17. This produces a connection between the control chamber 21 and the leakage connection 19 so that the pressure in the control chamber 21 decreases. As a result, the piston 22 moves toward the piezoelectric actuator 2 and a valve needle connected to the piston 22 lifts away from its seat. The fuel injection at the valve needle begins in this manner.

If the injection is now to be terminated, the piezoelectric actuator 2 is triggered again, which causes it to return to its starting position once more. As a result, the valve element 15 can return to its first valve seat 16 again and consequently closes the connection between the control chamber 21 and the leakage connection 19. This causes a pressure to build up again in the control chamber 21, which moves the piston 22 back into its starting position and therefore the valve needle recloses the opening so that the injection of fuel is terminated. The resetting of the piezoelectric actuator 2 is also assisted by the prestressing spring 9. The resetting of the diaphragm 3 occurs due to its own tension. It should be noted, however, that the diaphragm 3 could also be reset by means of a spring element, which engages the force output region 32, for example.

According to the invention, during operation of the valve, the temperature compensation device 27 assures that a length change of the piezoelectric actuator 2 due to a temperature increase can be mechanically compensated for. In order to compensate for a length change of the piezoelectric actuator 2 possibly left uncompensated by the temperature compensation device 27, a space h1 is provided between the valve element 15 and the pressure element 13 on the diaphragm 3, as shown in FIG. 1, which space is a great deal smaller than the stroke of the piezoelectric actuator 2 and can compensate for an uncompensated length change of the piezoelectric actuator 2.

The diaphragm according to the invention consequently increases the stroke of the piezoelectric actuator 2 by a transmission ratio a/b. The transmission ratio can be changed in a relatively simple manner by changing the diameter of the bushing 8.

In addition to the stroke increase, the diaphragm 3 according to the invention also produces a seal between the piezoelectric actuator 2 and the fuel region of the valve, thus assuring that no fuel can come into contact with the piezoelectric actuator 2 and consequently impair its operation. This makes it possible to eliminate the sealing element, which is otherwise required with the use of piezoelectric actuators and is usually provided directly on the piezoelectric actuator 2. This permits a further reduction in the manufacturing costs for the valve according to the invention.

The fact that the diaphragm 3 is bent at an angle α counter to the force direction F_{P} of the piezoelectric actuator 2 permits the tensile stresses in the clamping region of the diaphragm to be minimized. The angle α is the angle between the horizontal securing region 30 and the inclination in the force introduction region 31, as shown in FIG. 2.

Consequently, the current invention relates to a valve for controlling fluids, which includes a piezoelectric actuator 2, a transmission mechanism for increasing the stroke of the piezoelectric actuator 2, and a control valve 14 that can be actuated by means of the transmission mechanism. In addition, a temperature compensation device 27 is provided to compensate for a length change of the piezoelectric actuator 2 induced by a temperature change. The transmission mechanism is embodied as a diaphragm 3 and increases the stroke of the piezoelectric actuator with a transmission ratio a/b. At the same time, the diaphragm 3 seals the piezoelectric actuator 2 off from the fluid to be controlled.

The above description of the exemplary embodiment according to the current invention is intended for solely illustrative purposes and not to limit the invention. Various changes and modifications are possible without going beyond the scope of the invention and its equivalents.

1. A valve for controlling fluids, which includes a piezoelectric actuator (2), a transmission mechanism for increasing the stroke of the piezoelectric actuator (2), a control valve (14) that can be actuated by means of the transmission mechanism, and a temperature compensation device (27), wherein the transmission mechanism is embodied in the form of a diaphragm (3).

2. The valve according to claim 1, characterized in that the diaphragm (3) seals the piezoelectric actuator (2) off from the control valve (14).

3. The valve according to claim 1 or 2, characterized in that the temperature compensation device (27) is provided directly on the piezoelectric actuator (2).

4. The valve according to claim 3, characterized in that the temperature compensation device (27) includes a first base part (4), a second base part (5), and a sleeve (6), wherein the first base part (4) and the second base part (5) are respectively disposed at the end faces of the piezoelectric actuator (2) and the sleeve (6) encompasses the base parts (4, 5) and the piezoelectric actuator (2), wherein the temperature-induced length change of the first and second base parts (4, 5) and the piezoelectric actuator (2) essentially corresponds to the temperature-induced length change of the sleeve (6).

5. The valve according to one of claims 1 to 4, characterized in that the force is transmitted from the piezoelectric actuator (2) to the diaphragm (3) by means of a bushing (8).

6. The valve according to one of claims 1 to 5, characterized in that when the valve is not actuated, a space (h1) is provided between the diaphragm (3) and a valve element (15) of the control valve (14) or between the diaphragm (3) and the bushing (8) in order to compensate for additional temperature-induced length changes of the components.

7. The valve according to one of claims 1 to 6, characterized in that the diaphragm (3) has a force introduction region (31), which is bent at an angle (α) in relation to a securing region (30), counter to the force direction (F_{P}) of the piezoelectric actuator (2).

8. The valve according to claim 7, characterized in that between the securing region (30) and the force introduction region (30), the diaphragm (3) has a transition region embodied with a radius (R1).

9. The valve according to one of claims 1 to 8, characterized in that the diaphragm (3) is clamped by means of a ring nut (11).

10. The valve according to one of claims 1 to 9, characterized in that the control valve (14) is embodied as a valve that opens toward the outside.
